(19) United States
(12) Patent Application Publication
(10) Pub. No.: US 2012/0159090 A1
(43) Pub. Date: Jun. 21, 2012

(54) SCALABLE MULTIMEDIA COMPUTER SYSTEM ARCHITECTURE WITH QOS GUARANTEES

(75) Inventors: Jeffrey Andrews, Sunnyvale, CA (US); John V. Sell, Los Altos, CA (US); Susan Carrie, Mountain View, CA (US); Mark S. Grossman, Palo Alto, CA (US); John Tardif, Sammamish, WA (US); Nicholas R. Baker, Cupertino, CA (US)

(73) Assignee: MICROSOFT CORPORATION, Redmond, WA (US)

(21) Appl. No.: 12/970,361

(22) Filed: Dec. 16, 2010

(51) Int. Cl. G06F 12/00

(52) U.S. Cl. 711/153; 711/E12.001

(57) ABSTRACT

Versions of a multimedia computer system architecture are described which satisfy quality of service (QoS) guarantees for multimedia applications such as game applications while allowing platform resources, hardware resources in particular, to scale up or down over time. Computing resources of the computer system are partitioned into a platform partition and an application partition, each including its own central processing unit (CPU) and, optionally, graphics processing unit (GPU). To enhance scalability of resources up or down, the platform partition includes one or more hardware resources which are only accessible by the multimedia application via a software interface. Additionally, outside the partitions may be other resources shared by the partitions or which provide general purpose computing resources.

### BACKGROUND

A multimedia software application executing on a multimedia computer system often is provided certain quality of service (QoS) guarantees with respect to allocation of computing resources such as hardware, firmware or software components of the computer system. This is especially true for games. For example, there may be an assigned memory allocation size available to every game. A multimedia computer system may also guarantee that previous versions of an application such as a game will still run, so the QoS guarantees can exist for quite a number of years.

A multimedia computer system, particularly a gaming console, now typically provides common functions as part of the services of its platform. Examples of platforms are XBOX®, the Sony Playstation 3®, or Nintendo Wii®. Common functions are services which many types of games or other applications use or with which they are compatible. Some examples of common platform functions are display plane blending, display output recording, audio codec encoding, user device music decode and mixing, automatic camera based player identification, etc. Additionally, platform services may include functions which are independent of, but which run concurrently with, the multimedia application. As many games and other multimedia applications are interactive over the Internet now, the platform services may process the Internet protocol messages, provide online chat, friend invites, e-mail and support for social networking services. Both the platform and the application may use common resources for performing their respective functions.

As the forms of network connectivity supporting interactive gaming and other multimedia content keep evolving and certain processing aspects of applications become standard, the platforms provide more and more services over time for various applications while still being subject to the same QoS guarantees for these multimedia applications, thus increasing shared resource contention.

### SUMMARY

The technology provides various embodiments of a multimedia computer system architecture satisfying quality of service (QoS) guarantees for multimedia applications while allowing platform services to scale over time. The scaling over time may permit new services or enhanced current services. Platform services may scale down over time as well.

In an embodiment of a multimedia computer system for providing consistent performance for an executing multimedia application in accordance with one or more quality of service (QoS) guarantees, the system comprises a platform partition of computing resources, an application partition of computing resources, and at least one shared resource. The platform partition comprises computing resources including a platform central processing unit (CPU) and a platform graphics processing unit (GPU). The application partition comprises computing resources including an application CPU and an application GPU. In some embodiments, the application processing units perform processing exclusive of executing instructions of a platform service application.

In some embodiments, the system further comprises a shared resource accessible by a platform partition resource and an application partition resource.

In some embodiments of the multimedia computer system, to enhance scalability of resources up or down, the platform partition includes one or more resources which perform processing for one or more platform service applications and the multimedia application but which are only accessible by the multimedia application via a software interface.

Additionally, one or more shared computing resources may comprise an additional CPU which may execute instructions for a platform service application or the multimedia software application to provide consistent performance for the multimedia application based on the one or more QoS guarantees for the multimedia application. In some embodiments, an additional CPU may execute a general purpose operating system.

Embodiments of one or more computer readable storage media having encoded thereon software which when executed by a processor causes the processor to perform a method for allocating a computing resource between a multimedia application executing concurrently with one or more platform service applications to provide consistent performance of the multimedia application based on one or more QoS guarantees are also provided.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates an example embodiment of a target recognition, analysis, and tracking system with users participating in a game.

FIG. 2 illustrates an example embodiment of a console computing system communicatively coupled with a capture device.

FIG. 3A is a block diagram of an embodiment of a multimedia computer system architecture providing QoS multimedia guarantees with scalable platform services.

FIG. 3B is a block diagram of another embodiment of a multimedia computer system architecture like that of FIG. 3A with an additional shared CPU and GPU.

FIG. 3C is a flowchart of an embodiment of a method for changing the operation mode of at least one processing unit between a multimedia mode and a general purpose computing mode.

FIG. 4 illustrates another example embodiment of a multimedia computing system such as may be embodied in a console.

FIG. 5A is a block diagram of an embodiment of a multimedia computer system architecture providing QoS multimedia guarantees with scalable platform services.

FIG. 5B is a block diagram of another version of the embodiment of a multimedia computer system architecture providing QoS multimedia guarantees of FIG. 5A.

FIG. 6 is a flowchart describing one embodiment of a method for allocating a computing resource between the multimedia application and a platform service application based on one or more quality of service (QoS) guarantees for the multimedia application.

FIG. 7 is a flowchart describing one embodiment of a process implementing priority as a QoS guarantee processing technique for a latency guarantee.

FIG. 8 is a flowchart illustrating an example of a QoS guarantee method for processing a memory request based on criteria for providing consistent real-time performance.

### DETAILED DESCRIPTION

Multimedia content can include any type of audio, video, and/or image media content received from media content sources such as content providers, broadband, satellite and cable companies, advertising agencies the internet or video streams from a web server. As described herein, multimedia content can include recorded video content, video-on-demand content, television content, television programs, advertisements, commercials, music, movies, video clips, and other on-demand media content. Other multimedia content can include interactive games, network-based applications, and any other content or data (e.g., program guide application data, user interface data, advertising content, closed captions, content metadata, search results and/or recommendations, etc.).

Multimedia applications such as interactive games executing on a multimedia computer system provide a user experience with real-time updates of a highly complex scene display with 3D graphics responsive to user input. For example, game applications need to update in real time the fast-paced actions of avatars, other animated characters and moving objects. Additionally, complex backgrounds and visual effects need to be updated as well. In early multimedia console generations (i.e. Atari 2600 through Multimedia Cube and PS2), multimedia applications executed on gaming consoles with little or no remote connectivity. Often, an application had its own code for performing all the tasks need to create the user experience.

Platforms of computing resources provide standardized frameworks for multimedia application developers developed. A computing resource may be hardware, firmware, software, or a combination of two or more of these. As common functions developed and connectivity demands developed for remote users who wanted to interact together with a multimedia application, more recent generations of multimedia consoles like XBox®, XBox360®, Kinect®, Sony Playstation 3®, or Nintendo Wii®, provide platform services software that provides common functions for all multimedia applications executing on these computer systems, and other platform service applications that run services independently of the multimedia applications. The platform services and multimedia applications often execute concurrently. Contention for resources between the applications can result in reduced performance that impairs the user experience.

Platform service applications enhance the user's multimedia experience. Platform service applications are not the functions of an operating system or a hypervisor. Like a multimedia application, a platform services application may work with the operating system or hypervisor or system software. Examples of platform services are Internet protocol processing such as packaging data in standard message formats for Internet based functions like e-mail, social networking, instant messaging, and chat, and displays for these functions, including live voice chat and live video sharing. Other examples of common functions are maintaining user profiles and presenting menus which are independent of a particular multimedia application The data is formatted in a form usable by all applications supported by the multimedia computer system. The platform provides standardized interfaces with which multimedia developers program their multimedia applications. An example of such an interface is an application programming interface (API).

To ensure the viability of multimedia applications over time and encourage series of multimedia applications, quality of service (QoS) guarantees for features and performance for multimedia applications were implemented in multimedia computer system design, particularly for gaming consoles. This is one of the defining high-level features of multimedia consoles compared to other hardware devices like personal computers and cellular telephones. Generally, the same version of a multimedia application's code that runs on the first console shipped is guaranteed to also run with the same user discernable performance on the last console shipped, for example 4-10 years later.

Some examples of QoS guarantees are those relating to real-time latency and bandwidth requirements. For example, a memory read may be guaranteed to complete within a certain time window. In another example, an allocation of bus bandwidth may be guaranteed for certain data transfers. Over time, the multimedia applications have more memory and bandwidth requirements as the amount of data and the processing work increases to provide ever more immersive user experiences in real-time. Additionally, the platform provides new services to support new forms of connectivity and social networking to enhance the user experience as well as new bandwidth and latency requirements for data transferred using them. The platform services also provide new common functions or improve the performance of current functions to support the multimedia improvements in the user experience.

To provide consistent performance for a multimedia application over time, typically based on QoS guarantees with respect to features and performance (e.g. bandwidth and latency) and to allow platform services to scale, different architectural techniques to reduce contention and improve performance can be used. For example, dedicated hardware may be allocated separately for platform and application resources for hardware resources that in previous systems experienced very high concurrent utilization. In other examples, such as for bandwidth and latency guarantees, certain hardware resources like busses and memory can be overbuilt meaning the resource has capacity in excess of the expected or guaranteed uses of the resource. This approach also provides a growth cushion for expansion of platform services or changes in the guarantees. In other examples, QoS software executes in accordance with a method for allocating a resource between one or more platform service applications and a multimedia application in accordance with criteria for providing the multimedia application consistent performance based on the applicable QoS guarantees.

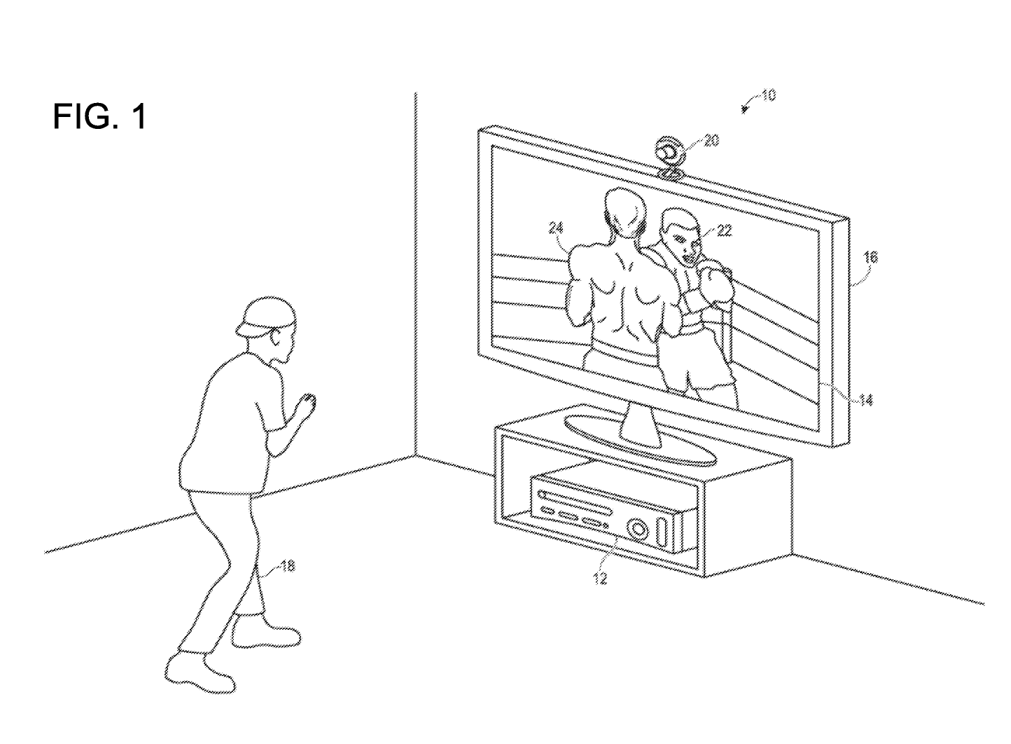

FIG. 1 provides a contextual example in which the present technology can be useful. FIG. 1 illustrates an example embodiment of a target recognition, analysis, and tracking system with a user interacting with an executing multimedia application in which embodiments of the technology can operate. In this example, a console computing environment 12 is illustrated. Other types of multimedia computer systems may also embodied the technology. Some examples of other types of computer systems which may embody the technology are a set-top box, a personal computer, or a mobile device like a laptop computer or a handheld computer device. The target recognition, analysis, and tracking system 10 may be used to recognize, analyze, and/or track a human target such as the user 18. Embodiments of the target recognition, analysis, and tracking system 10 include a console computing environment 12 for executing a gaming or other application, and an audiovisual device 16 for providing audio and visual representations from the gaming or other application. The system 10 further includes a capture device 20 for capturing positions and movements performed by the user in three dimensions (3D), which the computing environment 12 receives, interprets and uses to control the gaming or other application.

Embodiments of the console computing environment 12 may include computing resources of hardware, software components and/or firmware components such that the console 12 may be used to execute applications such as gaming and non-gaming applications. In one or more embodiment, the console computer system 12 may include a plurality of processors such as a standardized processor, a specialized processor, a microprocessor, or the like that may execute instructions stored on a processor readable storage device for performing processes described herein.

The system 10 further includes one or more capture devices 20 for capturing image data relating to one or more users and/or objects sensed by the capture device. In embodiments, the capture device 20 may be used to capture information relating to movements and gestures of one or more users, which information is received by the computing environment and used to render, interact with and/or control aspects of a gaming or other application. Examples of the console computing environment 12 and capture device 20 are explained in greater detail below.

Embodiments of the target recognition, analysis, and tracking system 10 may be connected to an audio/visual device 16 having a display 14. The device 16 may for example be a television, a monitor, a high-definition television (HDTV), or the like that may provide game or application visuals and/or audio to a user. For example, the console computing environment 12 may include a GPU and/or audio processing hardware and firmware or audio software running on general purpose CPUs that may provide audio/visual signals associated with the game or other application. The audio/visual device 16 may receive the audio/visual signals from the console computing environment 12 and may then output the game or application visuals and/or audio associated with the audio/visual signals to the user 18. According to one embodiment, the audio/visual device 16 may be connected to the console computing environment 12 via, for example, an S-Video cable, a coaxial cable, an HDMI cable, a DVI cable, a VGA cable, a component video cable, a DisplayPort compatible cable or the like.

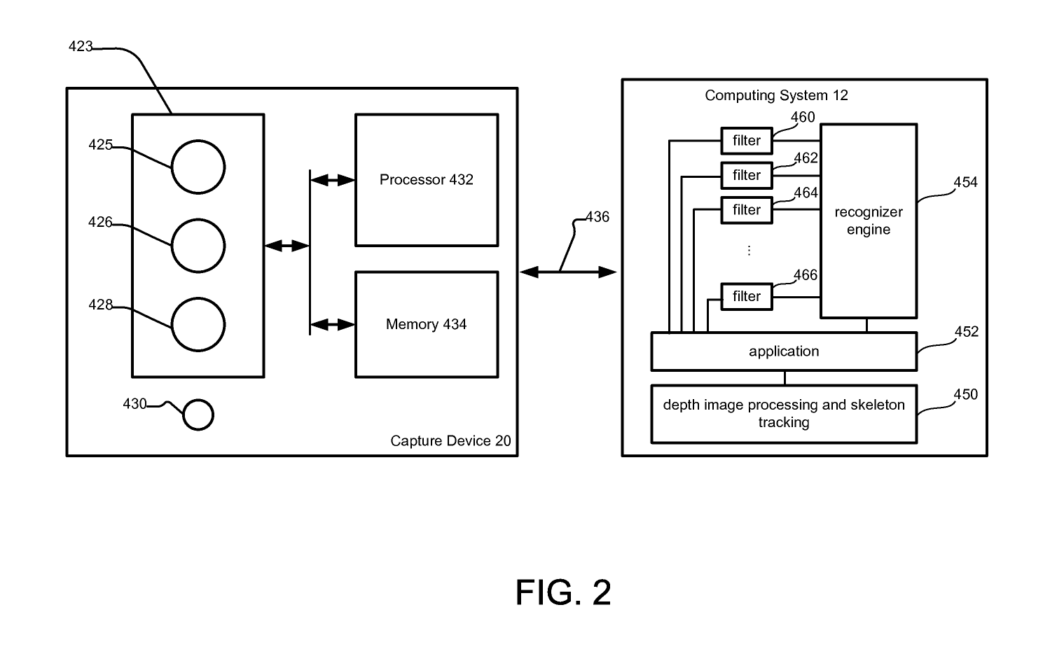

In an example embodiment, the application executing on the console computing environment 12 may be a game with real time interaction such as a boxing game that the user 18 may be playing. For example, the console computing environment 12 may use the audiovisual device 16 to provide a visual representation of a boxing opponent 22 to the user 18. The console computing environment 12 may also use the audiovisual device 16 to provide a visual representation of a player avatar 24 that the user 18 may control with his or her movements. For example, the user 18 may throw a punch in physical space to cause the player avatar 24 to throw a punch in game space. Thus, according to an example embodiment, the capture device 20 captures a 3D representation of the punch in physical space using the technology described herein. A processor (see FIG. 2) in the capture device 20 and the console computing environment 12 of the target recognition, analysis, and tracking system 10 may be used to recognize and analyze the punch of the user 18 in physical space such that the punch may be interpreted as a gesture or game control of the player avatar 24 in game space and in real time.

The multimedia console 12 may be operated as a standalone system by simply connecting the system to a television or other display. In this standalone mode, the multimedia console 12 allows one or more users to interact with the system, watch movies, or listen to music. However, with the integration of broadband connectivity made available through a network interface or a wireless adapter, the multimedia console 12 may further be operated as a participant in a larger network community.

FIG. 2 illustrates an example embodiment of console computing system communicatively coupled with a capture device. According to an example embodiment, capture device 20 may be configured to capture video with depth information including a depth image that may include depth values via any suitable technique including, for example, time-of-flight, structured light, stereo image, or the like. According to one embodiment, the capture device 20 may organize the depth information into “Z layers,” or layers that may be perpendicular to a Z axis extending from the depth camera along its line of sight.

As shown in FIG. 2, capture device 20 may include a camera component 423. According to an example embodiment, camera component 423 may be or may include a depth camera that may capture a depth image of a scene. The depth image may include a two-dimensional (2-D) pixel area of the captured scene where each pixel in the 2-D pixel area may represent a depth value such as a distance in, for example, centimeters, millimeters, or the like of an object in the captured scene from the camera.

Camera component 423 may include an infra-red (IR) light component 425, a three-dimensional (3-D) camera 426, and an RGB (visual image) camera 428 that may be used to capture the depth image of a scene. For example, in time-of-flight analysis, the IR light component 425 of the capture device 20 may emit an infrared light onto the scene and may then use sensors (in some embodiments, including sensors not shown) to detect the backscattered light from the surface of one or more targets and objects in the scene using, for example, the 3-D camera 326 and/or the RGB camera 428. In some embodiments, pulsed infrared light may be used such that the time or a phase shift between an outgoing light pulse and a corresponding incoming light pulse may be measured and used to determine a physical distance from the capture device 20 to a particular location on the targets or objects in the scene. According to another embodiment, the capture device 20 may include two or more physically separated cameras that may view a scene from different angles to obtain visual stereo data that may be resolved to generate depth information. Other types of depth image sensors can also be used to create a depth image.

The capture device 20 may further include a microphone 430, which includes a transducer or sensor that may receive and convert sound into an electrical signal. Microphone 430 may be used to receive audio signals that may also be provided to console computing system 12.

In an example embodiment, the capture device 20 may further include a processor 432 that may be in communication with the image camera component 423. Processor 432 may include a standardized processor, a specialized processor, a microprocessor, or the like that may execute instructions including, for example, instructions for receiving a depth image, generating the appropriate data format (e.g., frame) and transmitting the data to console computing system 12.

Capture device 20 may further include a memory 434 that may store the instructions that are executed by processor 432, images or frames of images captured by the 3-D camera and/or RGB camera, or any other suitable information, images, or the like. According to an example embodiment, memory 434 may include random access memory (RAM), read only memory (ROM), cache, flash memory, a hard disk, or any other suitable storage component. As shown in FIG. 2, in one embodiment, memory 434 may be a separate component in communication with the image capture component 423 and processor 432. According to another embodiment, the memory 434 may be integrated into processor 432 and/or the image capture component 422.

Capture device 20 is in communication with console computing system 12 via a communication link 436. The communication link 436 may be a wired connection including, for example, a USB connection, a Firewire connection, an Ethernet cable connection, or the like and/or a wireless connection such as a wireless 802.11b, g, a, or n connection. According to one embodiment, console computing system 12 may provide a clock to capture device 20 that may be used to determine when to capture, for example, a scene via the communication link 436. Additionally, the capture device 20 provides the depth information and visual (e.g., RGB) images captured by, for example, the 3-D camera 426 and/or the RGB camera 428 to console computing system 12 via the communication link 436. In one embodiment, the depth images and visual images are transmitted at 30 frames per second; however, other frame rates can be used. Console computing system 12 may then create and use a model, depth information, and captured images to, for example, control an application such as a game or word processor and/or animate an avatar or on-screen character.

Console computing system 12 includes depth image processing and skeletal tracking module 450, which uses the depth images to track one or more persons detectable by the depth camera function of capture device 20. Depth image processing and skeletal tracking module 450 provides the tracking information to application 452, which can be a video game, productivity application, communications application or other software application etc. The audio data and visual image data is also provided to application 452 and depth image processing and skeletal tracking module 450. Application 452 provides the tracking information, audio data and visual image data to recognizer engine 454. In another embodiment, recognizer engine 454 receives the tracking information directly from depth image processing and skeletal tracking module 450 and receives the audio data and visual image data directly from the capture device 20. In some embodiments, depth image processing and skeletal tracking module 450 may be considered a shared resource and other embodiments, it may be considered a platform resource which performs processing for a multimedia application as well.

Recognizer engine 454 is associated with a collection of filters 460, 462, 464, . . . , 466 each comprising information concerning a gesture, action or condition that may be performed by any person or object detectable by capture device 20. For example, the data from capture device 20 may be processed by filters 460, 462, 464, . . . , 466 to identify when a user or group of users has performed one or more gestures or other actions. Those gestures may be associated with various controls, objects or conditions of application 452. Thus, console computing system 12 may use the recognizer engine 454, with the filters, to interpret and track movement of objects (including people).

Capture device 20 provides RGB images (or visual images in other formats or color spaces) and depth images to console computing system 12. The depth image may be a plurality of observed pixels where each observed pixel has an observed depth value. For example, the depth image may include a two-dimensional (2-D) pixel area of the captured scene where each pixel in the 2-D pixel area may have a depth value such as distance of an object in the captured scene from the capture device. Console computing system 12 will use the RGB images and depth images to track a user's or object's movements. For example, the system will track a skeleton of a person using the depth images. There are many methods that can be used to track the skeleton of a person using depth images. One suitable example of tracking a skeleton using depth image is provided in U.S. patent application Ser. No. 12/603,437, “Pose Tracking Pipeline” filed on Oct. 21, 2009, Craig, et al. (hereinafter referred to as the '437 Application), incorporated herein by reference in its entirety. The process of the '437 Application includes acquiring a depth image, down sampling the data, removing and/or smoothing high variance noisy data, identifying and removing the background, and assigning each of the foreground pixels to different parts of the body. Based on those steps, the system will fit a model to the data and create a skeleton. The skeleton will include a set of joints and connections between the joints. Other methods for tracking can also be used. Suitable tracking technologies are also disclosed in the following four U.S. patent applications, all of which are incorporated herein by reference in their entirety: U.S. patent application Ser. No. 12/475,308, “Device for Identifying and Tracking Multiple Humans Over Time,” filed on May 29, 2009; U.S. patent application Ser. No. 12/696,282, “Visual Based Identity Tracking,” filed on Jan. 29, 2010; U.S. patent application Ser. No. 12/641,788, “Motion Detection Using Depth Images,” filed on Dec. 18, 2009; and U.S. patent application Ser. No. 12/575,388, “Human Tracking System,” filed on Oct. 7, 2009.

Recognizer engine 454 includes multiple filters 460, 462, 464, . . . , 466 to determine a gesture or action. A filter comprises information defining a gesture, action or condition along with parameters, or metadata, for that gesture, action or condition. For instance, a throw, which comprises motion of one of the hands from behind the rear of the body to past the front of the body, may be implemented as a gesture comprising information representing the movement of one of the hands of the user from behind the rear of the body to past the front of the body, as that movement would be captured by the depth camera. Parameters may then be set for that gesture. Where the gesture is a throw, a parameter may be a threshold velocity that the hand has to reach, a distance the hand travels (either absolute, or relative to the size of the user as a whole), and a confidence rating by the recognizer engine that the gesture occurred. These parameters for the gesture may vary between applications, between contexts of a single application, or within one context of one application over time.

Application 452 may use the filters 460, 462, 464, . . . , 466 provided with the recognizer engine 454, or it may provide its own filter, which plugs in to recognizer engine 454. In one embodiment, all filters have a common interface to enable this plug-in characteristic. Further, all filters may utilize parameters, so a single gesture tool below may be used to debug and tune the entire filter system.

More information about recognizer engine 454 can be found in U.S. patent application Ser. No. 12/422,661, “Gesture Recognizer System Architecture,” filed on Apr. 13, 2009, incorporated herein by reference in its entirety. More information about recognizing gestures can be found in U.S. patent application Ser. No. 12/391,150, “Standard Gestures,” filed on Feb. 23, 2009; and U.S. patent application Ser. No. 12/474,655, “Gesture Tool” filed on May 29, 2009. both of which are incorporated herein by reference in their entirety.

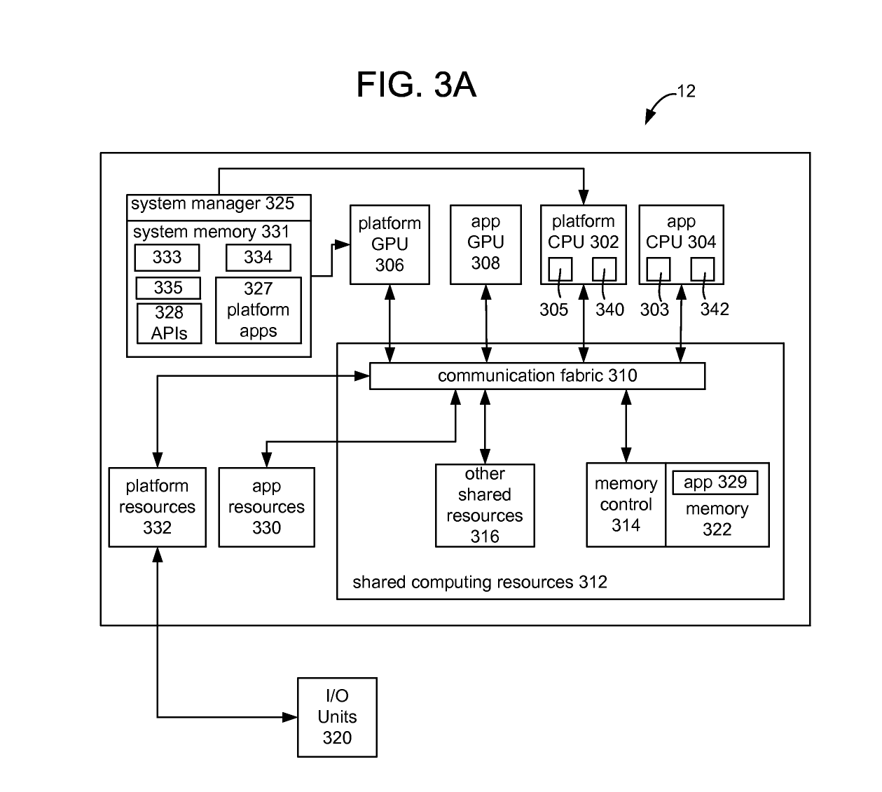

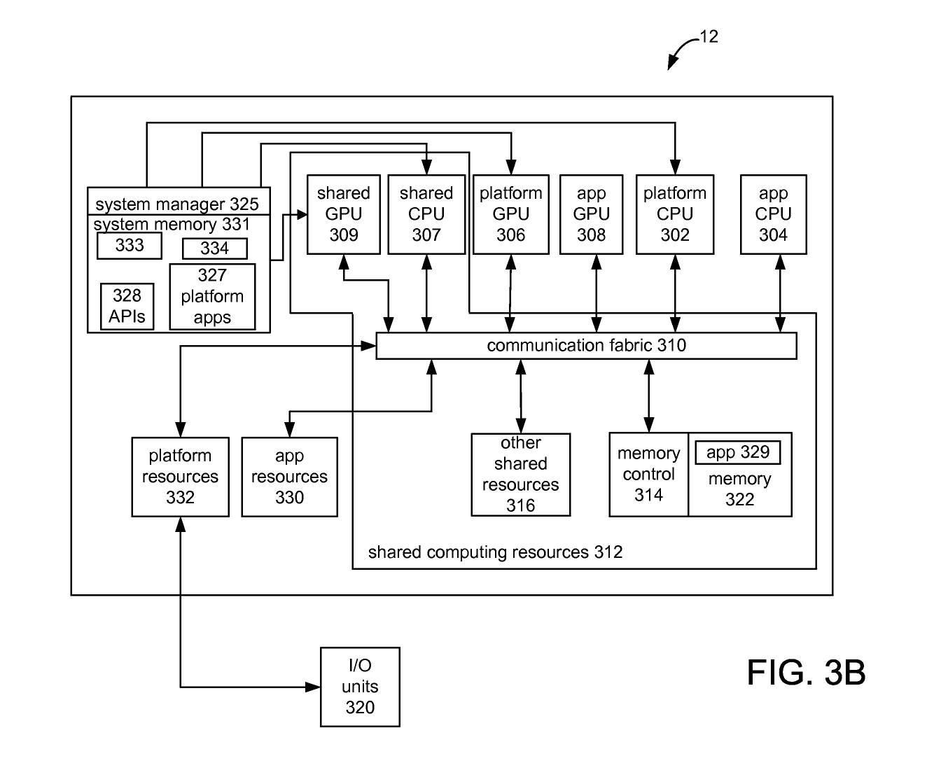

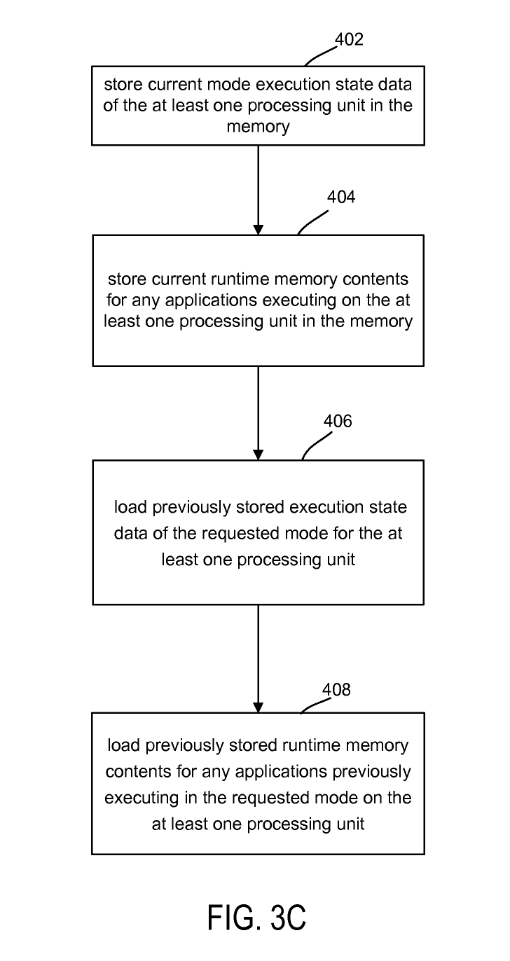

FIGS. 3A through 5B disclose embodiments of a multimedia computer system architecture providing multimedia application QoS guarantees while allowing computing resources supporting platform services applications to scale over time. In some embodiments, the QoS guarantees may be enforced by software controlled hardware resource allocation mechanisms. Hardware mechanisms are typically necessary (versus software mechanisms) when resource allocation must occur or update on a very fine-grained time basis (i.e. every clock cycle to tens of clock cycles) to ensure consistency of user perceived performance.

Besides QoS guarantees for multimedia applications, which are often developed by third parties, there may be system standards, e.g. with respect to latency and bandwidth applicable for all applications (e.g. platform, multimedia or other) or most applications running on the computer system. For example, even if a single platform service is running with no multimedia application like a game running, the system may enforce a system standard with respect to bandwidth and latency of the system communication fabric (e.g. bus or crossbar interconnect).

As illustrated in the figures below, some computing resources of the illustrated embodiments of multimedia computer systems, particularly hardware resources, are included in a platform partition or an application partition. For ease of description, computing resources in the platform partition are called platform resources, and computing resources in the application partition are called application resources. The partitions are logical partitions.

FIG. 3A is a block diagram of an embodiment of a multimedia computer system architecture providing QoS multimedia application guarantees with scalable platform services. Each of the platform services applications 327 and the multimedia application 329 rely on hardware dedicated primarily for processing their respective functions. The platform partition comprises resources such as a central processing unit (CPU) 302 and a graphics processing unit (GPU) 306, and other platform resources 332. Platform CPU 302 may be a single core processor or a multi-core processor. Platform CPU 302 includes cache 305. Various cache designs may be implemented for cache 305 and cache 303 of the application CPU. Cache temporarily stores data and hence reduces the number of memory access cycles, thereby improving processing speed and throughput. The platform CPU 302 further comprises a flash ROM (Read Only Memory) 340 which may store executable code that is loaded during an initial phase of a boot process when the multimedia computer system 12 is powered on. The GPU 306, as well as the application GPU 308 below, may have embedded memory for its data processing.

Some examples of other platform resources 332 are illustrated in the figures below. Such platform resources 332 may include providing input and output interfaces to input and output units 320, some examples of which are user input devices (user movements, game controllers, pointing devices), displays, image capture devices like camera 20, removable media (e.g. memory sticks, DVDs, memory drives), printers, and other devices which can connect via a Universal Serial Bus (USB), routers, and Ethernet cables. Some examples of resources which the platform resources 332 may provide include port input and output hardware and drivers such as audiovisual I/O units, USB port controllers, Ethernet ports or other Internet or network connection interfaces such as WiFi or other wireless protocols. Additionally, the platform resources 332 may include interfaces for removable media such a Serial Advanced Technology Attachment SATA (both ODD and HDD) interface for accessing, e.g. hot plugging, a high-density mass-storage flash.

The application partition comprises a CPU 304, a GPU 308, and other application resources 330. CPU 304 may also include one or more processing cores and includes cache 303 representative of one or more cache levels typically associated with processing units of one or more cores. In lower cost embodiments there may be distinct application and platform CPUs, but there may be a shared GPU which has its resource allocated via software and hardware mechanisms. The application CPU 304 further comprises a flash ROM 342 which may store executable code that is loaded during an initial phase of a boot process when the multimedia computer system 12 is powered on. The application resources 330 may include a high speed flash which is accessible only by an application processing unit.

In some embodiments, during concurrent execution of one or more platform services applications on at least one of the platform processing units and of the multimedia application on at least one of the application processing units, the application processing units do not execute the one or more platform services applications. In other words, the application processing units perform processing exclusive of executing instructions of a platform service application. The application processing units will execute code of the operating system, hypervisor and like standard system functions, but they are relieved of QoS guarantees of previous systems applicable to CPUs and GPUs such as a percentage of processing time for execution of concurrent platform services application. In the embodiments of providing separate processing units for platform services and multimedia applications, the caches and embedded RAM of the respective processing units in the respective partitions are not shared; and therefore, not thrashed due to application switching between a platform service application and a multimedia application.

Additionally, by partitioning the resources of the computer system, platform resources can operate independently of at least some of the QoS guarantees or can grow over time to lessen the effect of the guarantees, particularly as more platform services are provided due to hardware improvements. For example, an applicable QoS guarantee for GPU processing may only apply to the application GPU 308, but not the platform GPU 306.

Some embodiments may still impose a QoS guarantee that a certain percentage of processing time of the application processing units may be devoted to processing for one or more platform service applications. Such a guarantee may assist in keeping consistency of operation for the multimedia application over time. The guarantee may be enforced by inserting delay threads to take up the percentage of processing time. The platform services applications are preferably scheduled to run on the application CPU 308 at predetermined times and intervals in order to provide a consistent system resource view to the application. The scheduling is to minimize cache disruption for the gaming application running on the console.

System memory 331 is provided to store software code and data loaded during the boot process. In this example, system memory 331 stores the code of the platform service applications 327 which the platform processing units 302 and 306 may load. In this embodiment, QoS guarantee software 333 and priority schemes 333 are also stored in system memory. The QoS guarantee software may implement one or more priority schemes which may be useful in prioritizing requests for resources. For example, resources performing system critical functions like memory refresh and those performing functions with real-time requirements effecting the user experience may be assigned priorities and different applications like the multimedia application and the platform services applications may be assigned lower priorities. Some examples of functions with real-time requirements effecting the user experience are video output processing and other real-time data delivery cases using bandwith and high-latency to avoid glitched video at the TV or monitor or audible pops from speakers.

Furthermore, the QoS guarantee software 333 when executing may implement a QoS guarantee method with respect to memory requests based on criteria for providing consistent real-time performance or a consistent user experience. Some examples of such criteria are execution efficiency of each of the processing units; and memory channel efficiency. A processing unit does not tolerate latency well. Unused clock cycles are representative of inefficient execution efficiency for a CPU or GPU. An example of inefficient use of memory channels is activating too many memory banks at once. Another example is overloading one memory channel while another is idle.

Additionally, one or more software virtualization interfaces 328, in this example implemented as application programming interfaces (APIs), are executed from system memory 331 by the platform processing units 302 and 306, other logic or control units in other platform resources 332 or shared resources 312. In some embodiments, one or more of the virtualization interfaces 328 may implement a priority scheme 333 as well in processing requests for a resource.

Each hardware resource has a client identification (ID) which accompanies requests from the respective hardware resource. In some embodiments, the QoS guarantees or system standards that are applicable to a request are identified by the client ID of the requesting hardware resource. In some embodiments, the platform partition includes hardware devices which are virtualized to an executing multimedia application. The multimedia application accesses such a platform hardware device through a software virtualization interface executing on a platform processing unit or a shared processing unit in some cases. So the application partition does not need to be concerned with the actual hardware implementing the requested processing or resource, and the resource sees the client ID of the platform or shared device. Furthermore, a QoS guarantee applicable to a virtualized resource may stay the same for the application, e.g. a rate of display processing, while a video encoder in the platform partition is upgraded to a faster one which can handle more technologies.

The system memory 331 further includes partition allocation software 334. In some embodiments, the multimedia computer system may be one of several computers in a larger computer system sharing processing unit resources. In some embodiments, the multimedia computer system can include more than the representative processing units illustrated in FIG. 3A. As the partitions are logical, the partition allocation software 334 when executing may dynamically allocate a computing resource between the platform and application partitions. For example, in a cloud computing example, the partition allocation software 334 may receive a message over a network from another computer in the cloud to re-allocate its platform CPU and GPU as application CPU and GPUs due to more users joining an online interactive game. In such an example, it may be more efficient to have more processing units designated in the application partition than the platform services partition so there are more processing units available for the different executing instances of the multimedia application.

The system management controller 325 provides a variety of service functions related to assuring availability of the multimedia computer system 12. When the multimedia computer system 12 is powered on, platform application data 327 may be loaded from the system memory 331 for execution by the platform processing units 302, 306. The platform application may present a graphical user interface that provides a consistent user experience when navigating to different media types available on the multimedia computer system 12. In operation, multimedia applications 329 may be loaded from non-volatile memory 322 internal to the computer system or from an external media drive 320 from which it may be launched and played.

Each processing unit 302, 304, 306, and 308 interacts with a communication fabric 310. The communication fabric 310 for the system is an example of a shared computing resource 312 which may be accessed directly by resources of either partition. Some examples of a communication fabric are a bus or an interconnect fabric. In some embodiments, the communication fabric 310 can have excess bandwidth capacity to accommodate one or more latency QoS guarantees of the multimedia application while at the same time satisfying bus access requests from one or more platform services applications based on a system standard with respect to bandwidth or latency for the fabric. As the bandwidth exceeds the request amounts, there is negligible contention. This does allow for other platform service applications to be added over time, which will reduce the excess overhead. In another embodiment, each partition processing unit or at least each partition CPU may have a virtual private bus channel in a crossbar scheme. In other examples, each partition processing unit or the processing units of a partition may have its own physically separate bus. Besides an excess capacity approach, a priority scheme based, at least in part, on the QoS guarantees may be used to ration access if concurrent requests cannot be satisfied.

The shared resources 312 further include a memory controller 314 for accessing memory 322 which may include non-volatile, volatile memory or both which is accessible by applications. In one embodiment, memory 322 has effective bandwidth and latency performance in excess of the demands of one or more QoS guarantees for the multimedia application and one or more standard amount limits for a number of platform services executing at the same time. This effective bandwidth and latency performance may be implemented with excess memory size and more channels for accessing the memory. For example, models for one or more sets of platform services applications which execute typically concurrently may be developed based on different scenarios of user usage. The amount of effective bandwidth and latency performance for the memory may exceed the effective bandwidth and latency performance used during runtime of the set of platform applications which demand the most effective bandwidth and latency performance for the memory and the effective performance demanded by a QoS guarantee for the multimedia application to avoid user perceivable performance variation of the multimedia application. In one example, there may be an allocated amount or percentage of effective memory performance for the multimedia application, and requests from the platform or other system services are satisfied with unallocated bandwidth and latency resources.

In another instance, different operating scenarios, system standards or QoS guarantees or a combination of these may be used as a basis for criteria for setting a limit on the effective bandwidth and latency performance for memory which may be allocated during runtime as part of QoS guarantees or system standards. The memory controller 314 can then utilize unallocated capacity of the memory 322 to satisfy one or more QoS guarantees for the multimedia application.

FIG. 3B is a block diagram of another embodiment of a multimedia computer system architecture like that of FIG. 3A with an additional shared CPU and GPU. In this embodiment, there is another CPU and GPU provided by the system 12, shared GPU 309 and shared CPU 307. In one example, these system processing units 307, 309 may execute the APIs 328 which interact with the processing units of both partitions to process requests for resources located in the platform services partition or shared resources 312. This allows the platform services processing units 302, 306 to be free of the processing for the application units requests. In another embodiment, the shared GPU 309 and shared 307 may provide additional processing resources for executing instructions of a platform services application, instructions of the multimedia application or both based on the QoS guarantees.

In yet another embodiment, the shared CPU 307, the shared GPU 309, or both may execute a different general purpose operating system (e.g. Windows®) or provide additional functionality outside of that provided by either the platform services or the multimedia application. For example, these processing units 307, 309 may run a standard personal computer (PC) operating system and its associated graphical user interface, and the applications and services the PC OS provides or is compatible with such as Internet access via a browser, word processing, productivity, content generation and audiovisual applications.

In FIG. 3A, the system memory may also store mode change software 335. This is for a different embodiment wherein, instead of having a separate CPU and GPU for executing the multimedia computer system in a general purpose mode, the software switches out a CPU of one of the partitions, likely the application CPU to execute in a general purpose computer mode. The GPU of the partition may also be switched out. For ease of description, the mode wherein a multimedia application like a game executing with platform services is designated multimedia mode, and an operation mode wherein a general purpose operating system is executing is referred to as general purpose computer mode. A user may provide input via an input device indicating he or she desires to switch between modes. When switching between mode, the state of the system in the current executing mode is put in hibernation. The CPU, and the GPU, in some examples, is loaded with instructions and data is loaded into runtime memory as needed for executing the other mode. (The discussion focuses on switching between two modes for ease of description but modes may be changed between more than two modes.) If the mode being switched to previously had other applications running, the state of those applications may be restored to the point of the mode switch in some embodiments.

FIG. 3C is a flowchart of an embodiment of a method for changing the operation mode of at least one processing unit between a multimedia mode and a general purpose computing mode. In step 402, the mode change software 335 stores current mode execution state data of the at least one processing unit in memory (e.g. 322), and in step 404 stores current runtime memory contents for any applications executing on the at least one processing unit in the memory. Some examples of execution state data are the current contents of an instruction queue and the contents of the CPU or GPU registers, caches, embedded RAM or any other memory local to a processing unit, and state data for the operating system, displays and other system functions for the current mode. Some examples of runtime memory contents are process information, and data for any executing application stored in volatile or non-volatile memory by the system during the current execution instance of the application. In step 406, the mode change software 335 loads previously stored execution state data of the requested mode, the mode being changed to, for the at least one processing unit, and in step 408 loads the previously stored runtime memory contents for any applications previously executing in the requested mode on the at least one processing unit.

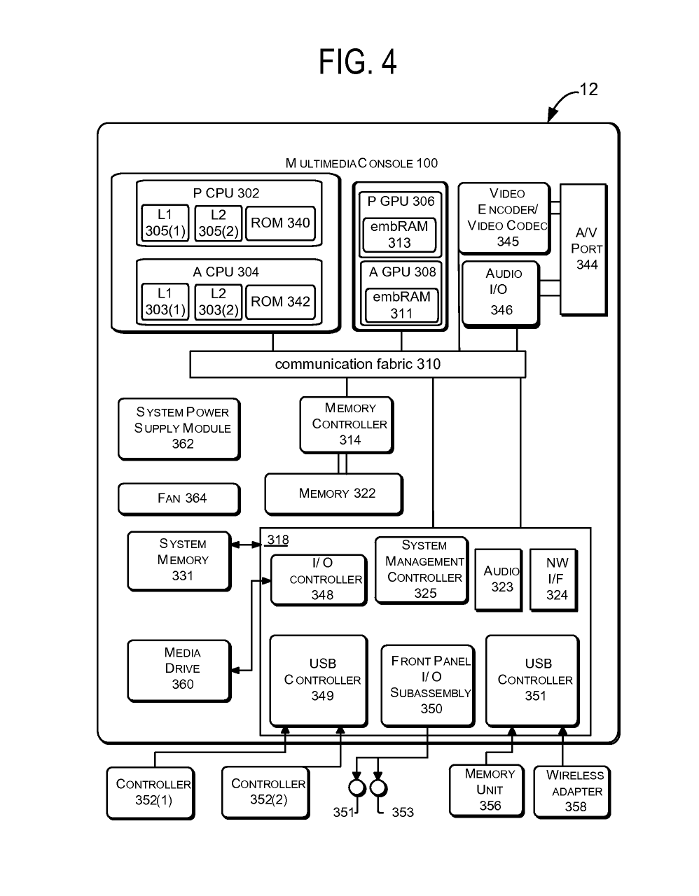

FIG. 4 illustrates another example embodiment of a multimedia computer system computing system architecture providing QoS multimedia guarantees with scalable platform services. A multimedia console 100 has a platform CPU 302 and an application CPU 304. For ease of connections in the drawings, the CPUs are illustrated in the same module; however, they are separate units and share no cache or ROM. Platform CPU 302 may be a single core processor or a multi-core processor. In this example, the platform CPU 302 has a level 1 cache 305(1) and a level 2 cache 305(2) and a flash ROM (Read Only Memory) 304.

The multimedia console 100 further includes the application CPU 304 for performing multimedia application functions. CPU 304 may also include one or more processing cores. In this example, the application CPU 304 has a level 1 cache 303(1) and a level 2 cache 303(2) and a flash ROM (Read Only Memory) 342.

The multimedia console 100 further includes a platform graphics processing unit (GPU) 306 and an application graphics processing unit (GPU) 308. For ease of connections in the drawings, the GPUs are illustrated in the same module; however, they are separate units and share no memory structures. Each GPU has its own embedded RAM 311, 313.

The CPUs 302, 304, GPUs 306, 308, memory controller 314, and various other components within the multimedia console 100 are interconnected via one or more buses, including serial and parallel buses, a memory bus, a peripheral bus, and a processor or local bus using any of a variety of bus architectures. By way of example, such architectures can include as well a Peripheral Component Interconnects (PCI) bus, PCI-Express bus, etc. for connection to an IO chip and/or as a connector for future IO expansion. Communication fabric 310 is representative of one or more of the various busses or communication links which may also have excess capacity as discussed for communication fabric 310 in FIG. 3A.

In this embodiment, each GPU and a video encoder/video codec (coder/decoder) 345 form a video processing pipeline for high speed and high resolution graphics processing. Data from the embedded RAM 311, 313 of a GPU 306, 308 is stored in memory 322. Video encoder/video codec 345 accesses the data in memory 322 via the communication fabric 310. The video processing pipeline outputs data to an NV (audio/video) port 344 for transmission to a television or other display.

Lightweight messages (e.g., pop ups) generated by an application, for example a platform chat application, are created by using the GPU to schedule code to render popup into an overlay video plane. The amount of memory used for an overlay plane depends on the overlay area size and the overlay preferably scales with screen resolution. Where a full user interface is used by the concurrent platform services application, it is preferable to use a resolution independent of application resolution. A scaler may be used to set this resolution such that the need to change frequency and cause a TV resync is eliminated.

A memory controller 314 facilitates processor access to various types of memory 322, such as, but not limited to, one or more DRAM (Dynamic Random Access Memory) channels.

The multimedia console 100 includes an I/O controller 348, a system management controller 325, audio processing unit 323, a network interface controller 324, a first USB host controller 349, a second USB controller 351 and a front panel I/O subassembly 350 that are preferably implemented on a module 318. The USB controllers 349 and 351 serve as hosts for peripheral controllers 352(1)-352(2), a wireless adapter 358, and an external memory device 356 (e.g., flash memory, external CD/DVD ROM drive, memory stick, removable media, etc.). The network interface 324 and/or wireless adapter 358 provide access to a network (e.g., the Internet, home network, etc.) and may be any of a wide variety of various wired or wireless adapter components including an Ethernet device, a modem, a Bluetooth module, a cable modem, and the like.

System memory 331 is provided to store application data that is loaded during the boot process. A media drive 360 is provided and may comprise a DVD/CD drive, Blu-Ray drive, hard disk drive, or other removable media drive, etc. The media drive 360 may be internal or external to the multimedia console 100. Application data may be accessed via the media drive 360 for execution, playback, etc. by the multimedia console 100. The media drive 360 is connected to the I/O controller 348 via a bus, such as a Serial ATA bus or other high speed connection (e.g., IEEE 1394).

The system management controller 325 provides a variety of service functions related to assuring availability of the multimedia console 100. The audio processing unit 323 and an audio codec 346 form a corresponding audio processing pipeline with high fidelity and stereo processing. Audio data is stored in memory 322 and accessed by the audio processing unit 323 and the audio input/output unit 346 which form a corresponding audio processing pipeline with high fidelity stereo and multichannel audio processing. When a concurrent platform services application requires audio, audio processing is scheduled asynchronously to the gaming application due to time sensitivity. The audio processing pipeline outputs data to the A/V port 344 for reproduction by an external audio user or device having audio capabilities.

The front panel I/O subassembly 350 supports the functionality of the power button 351 and the eject button 353, as well as any LEDs (light emitting diodes) or other indicators exposed on the outer surface of the multimedia console 100. A system power supply module 362 provides power to the components of the multimedia console 100. A fan 364 cools the circuitry within the multimedia console 100.

The multimedia console 100 may be operated as a standalone system by simply connecting the system to a television or other display. In this standalone mode, the multimedia console 100 allows one or more users to interact with the system, watch movies, or listen to music. However, with the integration of broadband connectivity made available through the network interface 324 or the wireless adapter 358, the multimedia console 100 may further be operated as a participant in a larger network community.

After multimedia console 100 boots and system resources are reserved, concurrent platform services applications execute to provide platform functionalities. The platform functionalities are encapsulated in a set of platform applications that execute within the reserved system resources described above. The operating system kernel identifies threads that are platform services application threads versus gaming application threads.

Optional input devices (e.g., controllers 352(1) and 352(2)) are shared by gaming applications and system applications. The input devices are to be switched between platform applications and the gaming application such that each will have a focus of the device. The I/O controller 348 preferably controls the switching of input stream, and a driver maintains state information regarding focus switches. Capture device 20 may define an additional input device for the console 100 via USB controller 349 or other interface.

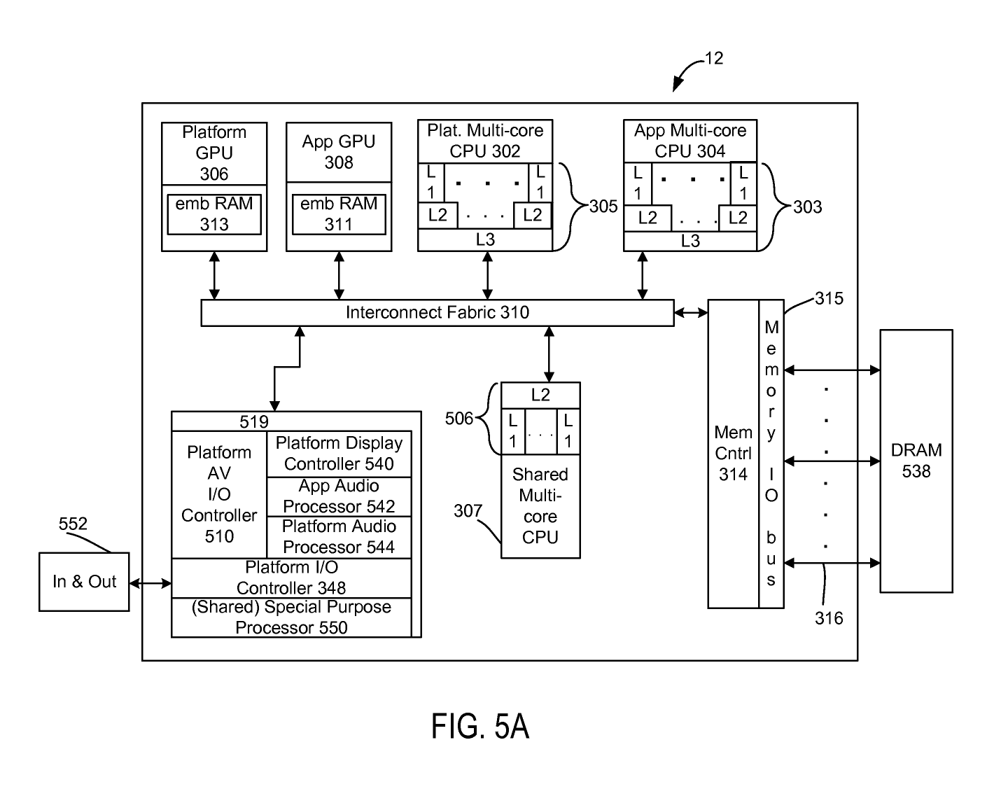

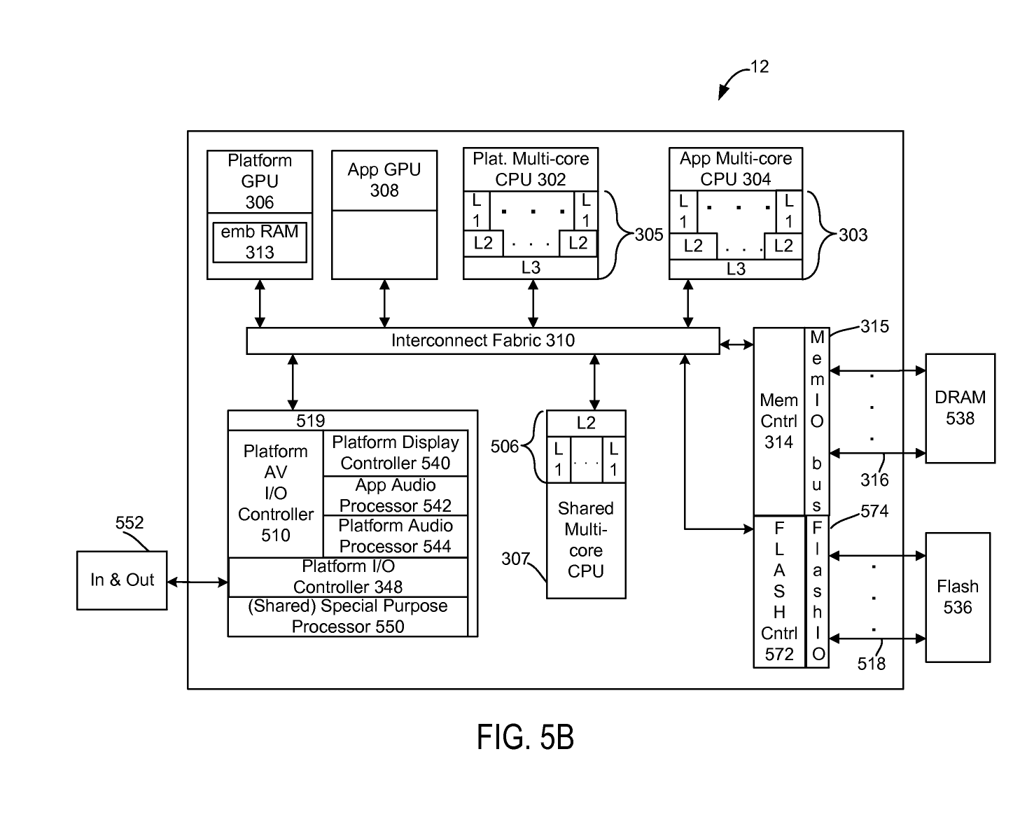

FIG. 5A is a block diagram of an embodiment of a game console computer system 12 architecture providing QoS multimedia guarantees with scalable platform services. Each of the exemplar processing units interfaces with an embodiment of a shared resource communication fabric 310 which in this case is an interconnect fabric 310. The fabric 310 may be an on-chip bus. Memory controller 314 controls a memory bus 315 for accessing shared memory, the examples shown here as a form of DRAM 538 via one or more of a number of memory channels 316.

In this embodiment, there are three CPUs and two GPUs. Platform GPU 306 is illustrated with embedded RAM 313. Application GPU 308 is also illustrated with embedded RAM 311. As mentioned above, a GPU may not have embedded memory in some embodiments. Platform CPU 302 is illustrated with an embodiment of cache 305 as L1 caches, typically for instruction and for data, and L2 cache. Application CPU 304 is illustrated with an embodiment of cache 306 as L1 caches, typically for instruction and for data, L2 cache and L3 cache. Shared CPU 307 is illustrated as a multi-core CPU with an embodiment of cache 506 of L1 and L2 caches.

Module 519 illustrates a number of input and output controllers. The audio processing units 542 and 544 are illustrative of the dedicated hardware approach. The application audio processor unit 542 is part of the application hardware partition in this example and does not have to perform audio processing for platform services applications. The platform audio processor 544 performs audio processing for one or more platform services applications and for some multimedia application audio tasks requested through a platform service software API 328. Each audio processor unit may include hardware or a Digital Signal Processor (DSP) or CPU executing firmware for encoding and decoding audio data received from or output to the platform AV I/O controller 510. Different audio can be input and output on different channels in parallel. For example, users playing a game can have their audio on one channel while the audio of the game is playing on another channel.

The shared special processor 550 may provide extra computing resources. Some examples of processing for which the special processor 550 may assist are audio and video processing, sensor processing, and image data processing. Other than the shared special processor 550, the other illustrated I/O controllers are examples of resources in the platform services partition which the multimedia application access through a software virtualization interface 328 (e.g. API). Some of these resources are for shared hardware devices that have little performance impact such as user input and output device (e.g. game controllers, keyboards, pointing devices). Either they are lower bandwidth, or the current required latencies (to meet user experience requirements) are very long, or they have inherent retry capability. Other examples of these types of hardware devices which are not time critical include, but are not limited to: Ethernet, WiFi, SATA (both ODD and HDD), high-density mass-storage flash, USB (for many device types), etc.

There is another class of resources that will be virtualized from the game application partition point of view, and the platform service partition will sufficiently hide the performance guarantees, even though there are real-time latency and BW requirements. Examples of such resources include hardware resources like the platform display controller 540 video decoders/encoders (i.e. VC-1, H.264, MPEG-2, MPEG-4, etc.), video quality blocks (i.e. motion adaptive de-interlacing, speckle reduction, jitter reduction, etc.), the platform I/O controller 348 (e.g. a PCI-e Express interface), and the platform audiovisual (AV) input/output interface controller 510 (e.g. which accepts camera inputs 552)). These blocks are directly related to real-time video, which have critical real-time requirements for the user experience. In these cases, a software API 328 is used by the game application 329 for access. Usage models for consistent real-time performance are used to avoid drop-outs or errors due to underflow/overflow or other low-level QoS issues in the platform as an overall system. The platform audiovisual controller 510 controls the audiovisual input/output interface with an audiovisual device or separate display and audio output devices. Examples of interfaces which may be used include a version of DisplayPort (DP), a high definition multimedia interface (HDMI) and Sony/Philips Digital Interconnect Format (S/PDIF) for digital audio signals.

FIG. 5B is a block diagram of another embodiment of a multimedia console architecture providing QoS multimedia guarantees with scalable platform services which is similar to FIG. 5A except that in this embodiment, the application partition includes a high speed, random access flash memory controller 572 for controlling transfer of over one or more channels 518 of a flash memory interface 574 to access high speed, random access flash 536. In this example, the partition allocation software 334 has mapped the application processing units 304, 308 to allow them access to the high speed random access flash 536, but not the platform processing units 306, 302.

The example computer systems illustrated in FIGS. 2 through 5B include examples of computer readable storage media. Such media may include volatile and nonvolatile, removable and non-removable media implemented in any method or technology for storage of information such as computer readable instructions, data structures, program modules or other data. Computer storage media includes, but is not limited to, RAM, ROM, EEPROM, cache, flash memory or other memory technology, CD-ROM, digital versatile disks (DVD) or other optical disk storage, memory sticks or cards, magnetic cassettes, magnetic tape, a media drive, a hard disk, magnetic disk storage or other magnetic storage devices, or any other medium which can be used to store the desired information and which can accessed by a computer.

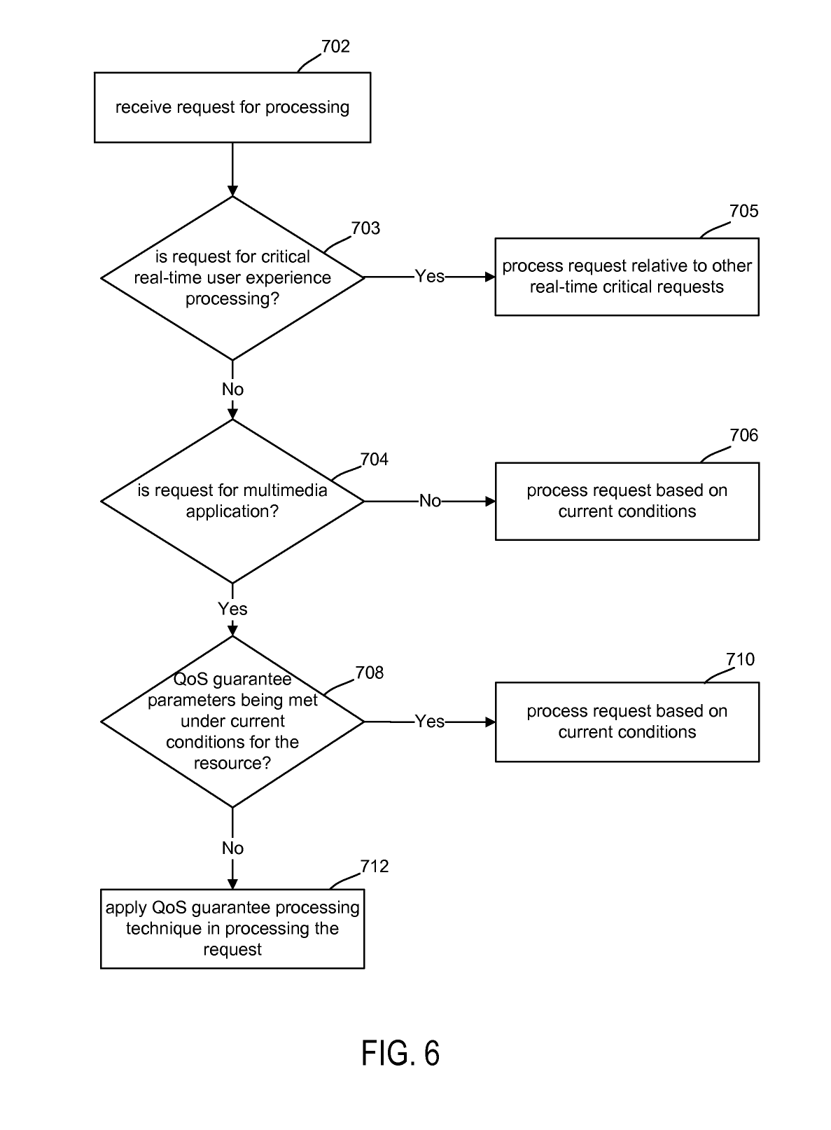

FIG. 6 is a flowchart describing one embodiment of a process for allocating a computing resource between the multimedia application and a platform service application based on one or more quality of service (QoS) guarantees for the multimedia application. In step 702 a software interface API 328 receives a request for processing and determines in step 703 whether the request is for a resource performing critical real-time processing effecting the user experience. If so, the request is processed in step 705 relative to other real-time critical requests. For example, a DRAM refresh may be prioritized over a memory read for video data for the display. If the request is not from a resource performing critical real-time user experience processing, then in step 704, the software API 328 determines whether the request is for the multimedia application. In one example, the client ID may identify the request from an application partition resource. In another example, the request may be from a platform resource but includes a data field indicating it is for the multimedia application executing. Responsive to the request being for an application other than the multimedia application 329, the resource processes the request in step 706 based on current conditions for the resources in the multimedia computer system 12.

Current conditions generally refers to the current operation state of the computer system and of particular resources which are currently executing. For example, the multimedia application may be loaded in runtime memory and executing, but it is in a “pause” state as the user has switched over to a menu screen of a platform service application or has hit “pause”. This state of operation will likely lower the priority of requests of the application. As per a stored priority scheme 333 in FIG. 3A, there may also be concurrent system functions like a DRAM refresh or a high security threat which are much higher in priority than an application request for a resource as they effect the integrity of the operation of the computer system itself. There may also be platform services which take precedence over multimedia application requests due to their critical real-time performance windows which can adversely effect the user experience. Some examples would be audio out processing and audio mixing. Another example is a video display output which needs to update a display in microsecond timeframes or else some pixels on a display will be black areas as the display data did not update in time. In some instances, camera image data for natural user interface (NUI) systems may have a higher relative priority than a type of request from the application CPU 304. Additionally, software such as the QoS guarantee software 333 may rearrange priorities of requests in programmable queues for different resources based on a priority scheme 333.

If the request is for the multimedia application, the software interface 328 in step 708 determines whether QoS guarantee parameters are being met under current conditions for the requesting resource. For example, the video encoder 345 may have two requests ahead of the request for the multimedia application but each is of a data size that the QoS latency guarantee for sending streaming video for the multimedia application will still be satisfied. When the request can be satisfied under current conditions for the resource, in step 710 the resource processes the request based on the current conditions. If the applicable QoS guarantee parameters cannot be met under the current resource conditions, the resource allocation control unit 620 in step 712 applies a QoS guarantee processing technique in processing the request.

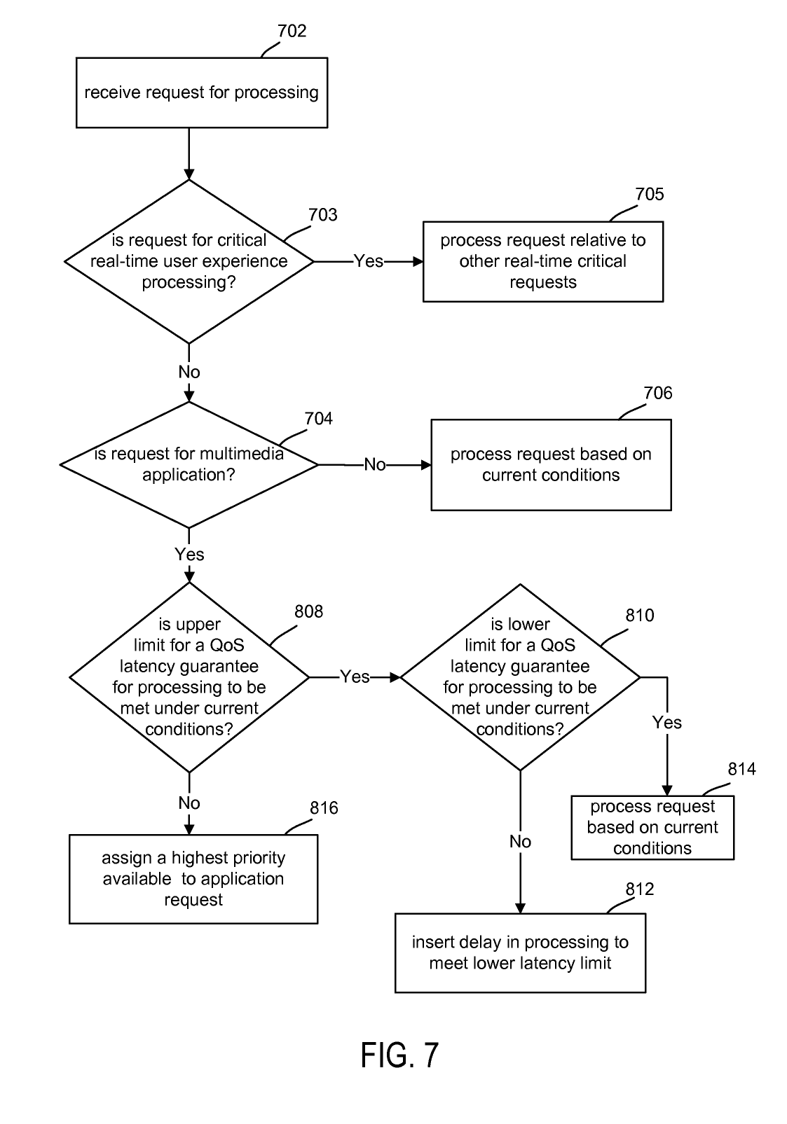

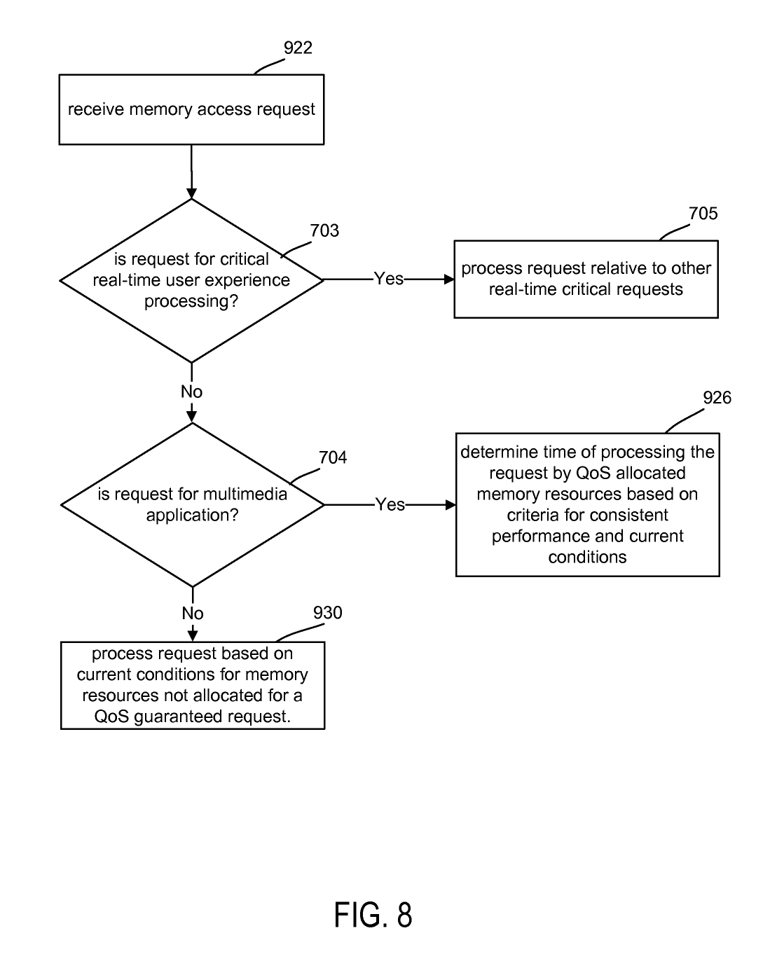

FIGS. 7 and 8 provide implementation examples of applying QoS guarantee processing techniques of the process of FIG. 6.

FIG. 7 is a flowchart describing one embodiment of a process implementing priority as a QoS guarantee processing technique for a latency guarantee. Steps 702 through 706 are performed as discussed above for FIG. 6. If the request is for the multimedia application, the API 328 determines in step 808 whether an upper or maximum limit of a QoS latency guarantee for processing can be met under current conditions for the resource. An example of an upper limit is a maximum amount of time for processing a memory access request. Another example of an upper limit is a time limit based on a display refresh rate. For example, game applications are typically 30 Hz or 60 Hz real time based, and there are many performance critical sections within each frame time, which bounds the upper limit on the time window over which QoS is performed. If the request cannot meet the QoS guarantee latency upper limit under the current conditions, the API 328 assigns a highest priority available to the multimedia application request in step 816. For example, the request may be moved up in a queue of requests with the objective of satisfying the upper limit. A range of priority values may be available to the multimedia application, for example as per a priority scheme 333 stored in system memory 331.

If the determination in step 808 is that the upper limit for the QoS latency guarantee can be met for processing under the current conditions, in step 810, the software API 328 determines whether a lower limit for an applicable latency QoS guarantee can be met under current conditions. For some resources, there may be lower limits, for example a lower limit on a time window, to have stable behavior in the QoS implementation. The lower limit can prevent or decrease QoS active intervention from occurring too often which will impair other performance enhancements throughout the computer system console. For example, hardware devices like user input devices have little performance impact due to their low bandwidth use, comparatively long latency guarantees compared to other resources or they have inherent retry capability. If the lower or minimum limit is also satisfied under the current conditions for the resource, in step 814 the resource processes the request based on the current conditions. If the lower limit for the QoS guarantee for processing cannot be met under current conditions, the software API 328 in step 812 inserts delay in the processing to meet the lower or minimum limit requirement. In some embodiments, an upper or lower latency may apply for example for I/O devices and other interfaces such as an Internet connection where the input or data is likely to be sent again even if not processed the first time.

FIG. 8 is a flowchart illustrating an example of a QoS guarantee method for processing a memory request based on criteria for providing consistent real-time performance. In step 922, the QoS guarantee software 333 for memory or an API 328 for the memory receives a memory access request. As per steps 703 and 705 previously discussed, if the request is for a resource performing real-time processing for the user experience, the request is processed relative to other real-time critical requests.

In step 704 the QoS guarantee software 333 for memory or a memory API 328 determines whether the request is from a resource performing processing for the executing multimedia application. If the request is for the multimedia application, then the memory QoS guarantee software 333, 328 determines in step 926 the time of processing the request by QoS allocated memory resources based on criteria for consistent performance and current conditions. As discussed for FIG. 3A, some examples of criteria for consistent performance include execution efficiency of each of the processing units and memory channel efficiency. As per current conditions, there may be requests from resources performing critical real time processing which provide for a consistent user experience and consistent performance of the computer system for that matter ahead of the request for the multimedia application. Additionally, system standards for memory requests may be part of the current conditions.

Responsive to the request not being for the multimedia application, in step 930 the QoS guarantee software 333 or a memory controller API 328 process the request based on current conditions for memory resources not allocated for a QoS guaranteed request for the multimedia application. The allocation of memory resources for QoS requests may be all or partially dynamic during execution in some embodiments. In other embodiments, the allocation of memory resources for QoS requests may be reserved memory for QoS guaranteed requests when a multimedia application is executing.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A multimedia computer system for performing processing subject to one or more quality of service (QoS) guarantees for a multimedia software application comprising:
a platform computing resources partition comprising a platform central processing unit (CPU) and a platform graphics processing unit (GPU); and
an application computing resources partition comprising an application CPU and an application GPU; and
a shared resource accessible by a platform partition resource and an application partition resource.

2. The multimedia computer system of claim 1, wherein:
the application CPU and the platform CPU are separate processors with no shared cache memory.

3. The multimedia computer system of claim 1, wherein:
the application GPU and the platform GPU are separate processors with no shared embedded RAM memory.

4. The multimedia computer system of claim 1, further comprising
one or more computer storage media having encoded thereon instructions for causing at least one of the processing units to dynamically allocate a computing resource between the platform and application partitions.

5. The multimedia computer system of claim 1, wherein:
the shared resource accessible by the platform partition resource and the application partition resource further comprises:
a communication fabric accessible to the platform CPU, the platform GPU, the application CPU, and the application GPU and having fabric bandwidth of an amount which satisfies a QoS latency guarantee for a request from the multimedia application and a standard amount for a request from one or more of the platform service applications at the same time.

6. The multimedia computer system of claim 1, wherein:
the shared resource accessible by the platform partition resource and the application partition resource further comprises:
a memory for use during execution of an instance of software and having a size which exceeds a QoS guaranteed amount for runtime memory for the multimedia application, and one or more amounts for a set of platform service applications to be executing at the same time.

7. The multimedia computer system of claim 1, wherein:
during concurrent execution of one or more platform services applications on at least one of the platform processing units and of the multimedia application on at least one of the application processing units, the application processing units do not execute the one or more platform services applications.

8. The multimedia computer system of claim 1, wherein:
the application partition includes an audio processing unit for performing audio processing exclusively for applications executing on the one or more application processing units.

9. The multimedia computer system of claim 1, wherein:
the shared resource is a memory accessible to the platform CPU, the platform GPU, the application CPU, and the application GPU; and
the system further comprises:
one or more computer storage media having encoded thereon instructions for causing a processor to execute a QoS guarantee method based on one or more quality of service (QoS) guarantees for the multimedia application with respect to the memory based on criteria including:
execution efficiency of each of the processing units; and
memory channel efficiency.

10. The multimedia computer system of claim 1, wherein:
the application computing resources partition further comprises a flash memory accessible only by the one or more application processing units.

11. The multimedia computer system of claim 1 further comprising:
the platform partition including one or more hardware resources which perform processing for one or more platform service applications and the multimedia application but which is only accessible by the multimedia application via a software interface.

12. The multimedia computer system of claim 11, wherein:
the one or more platform hardware resources which perform processing for the one or more platform service applications and the multimedia application but which is only accessible by the multimedia application via a software interface is an interface for connecting one or more external devices to the computer system.

13. The multimedia computer system of claim 12 further comprising:
one or more computer storage media having encoded thereon instructions for causing a processor to execute a QoS guarantee function based on one or more quality of service (QoS) guarantees for the multimedia application with respect to the interface for connecting one or more external devices to the computer system, the method comprising:
determining whether an upper limit for a QoS latency guarantee for processing input for the multimedia application by the interface cannot be met; and
responsive to the upper limit for the QoS latency guarantee not being met, assigning a highest priority available for processing the input based on current conditions;
determining whether a lower limit for a QoS latency guarantee for processing the input for the multimedia application from the interface cannot be met; and
responsive to the lower limit for the QoS latency guarantee not being met, inserting delay in processing to meet the lower latency limit.

14. The multimedia computer system of claim 12, wherein:
the interface is capable of connecting one or more external devices to the computer system from the group consisting of a camera, a user input device, an Internet connection device, and a storage medium.

15. A multimedia computer system for performing processing subject to one or more quality of service (QoS) guarantees for a multimedia software application comprising:
a platform computing resources partition comprising a platform central processing unit (CPU) and a platform graphics processing unit (GPU);
an application computing resources partition comprising an application CPU and an application GPU;
a memory accessible by each of the processing units; and
one or more computer storage media having encoded thereon instructions for causing at least one of the processing units to perform a method for changing an operation mode to a requested mode of the at least one processing unit between a multimedia mode and a general purpose computer mode.

16. The multimedia computer system of claim 15 wherein the method for changing the operation mode of the at least one processing unit between a multimedia mode and a general purpose computer mode comprises:
storing current mode execution state data of the at least one processing unit in the memory; and
storing current runtime memory contents for any applications executing on the at least one processing unit in the memory.

17. The multimedia computer system of claim 16 wherein the method further comprises:
loading previously stored execution state data of the requested mode for the at least one processing unit; and
loading previously stored runtime memory contents for any applications previously executing in the requested mode on the at least one processing unit.

18. A multimedia computer system comprising:
a platform computing resources partition comprising a platform central processing unit (CPU);
an application computing resources partition comprising an application CPU; and
a system CPU for executing a general purpose operating system concurrently with any of the application or platform processing units.

19. The multimedia computer system of claim 18 further comprising:
a system GPU for providing graphics processing for applications executing on the system CPU.

20. The multimedia computer system of claim 18 wherein either of the system CPU and the system GPU may be a shared resource by the platform partition and the application partition.
